(19) United States
(12) Patent Application Publication
(10) Pub. No.: US 2009/0189059 A1
(43) Pub. Date: Jul. 30, 2009

(54) SYSTEMS AND METHODS FOR CROSS-OVER BOND-WIRES FOR TIA INPUT

(76) Inventor: Darrell I. Smith, Bishop's Stortford (GB)

Correspondence Address: PATENT GROUP 2N;JONES DAY, NORTH POINT, 901 LAKESIDE AVENUE, CLEVELAND, OH, 44114, US

(21) Appl. No.: 12/021,332

(22) Filed: Jan. 29, 2008

(51) Int. Cl. G01J 1/44; H01S 3/00

(52) U.S. Cl. 250/214 LA; 359/337

(57) ABSTRACT

Systems and methods are provided for improving electromagnetic interference resistance in sensor-amplifier configurations. A sensor receives a stimulus and generates a current in response to the stimulus. The current is propagated to an amplifier circuit via a pair of cross-over bond-wires creating two counter rotating loop antennae where electromagnetic interference currents induced in one loop cancel interference currents induced in the second loop such that only the sensor current is propagated to the amplifier circuit. The amplifier circuit then amplifies the propagated sensor signal.

### FIELD

The technology described in this patent document relates generally to electromagnetic signal interference reduction and more particularly to reduction of electromagnetic signal interference from input signal amplification.

### BACKGROUND

Optical receiver modules used for receiving high speed—GHz—optical data signals propagating along an optical fiber are known to those of skill in the art. Typically within these optical receiver modules, there is an optical detector electrically coupled to an amplifier circuit in such a manner that light from the optical fiber illuminates the optical detector, the optical detector generates photocurrent in response thereto, and the amplifier circuit amplifies this current.

In sensor receiving applications, electromagnetic interference with the sensor signal is often a problem due to the severe difference in magnitude between the signal generated by the sensor and the relatively large amplified version of the sensor signal and other signals present throughout the circuit. For example, a typical photodiode may tend to generate a photocurrent in the range of microamps to milliamps. In contrast, representations of the photodiode signal amplified by a transimpedance amplifier and other signals traveling throughout the circuit are often in the magnitude range of 0.25 volts to 5 volts or greater. This signal, terminated into 50 Ohms, provides a circulating (RF) current of 5 milliamps to 100 milliamps at very close proximity to the photodiode which creates a large interference hazard that must be mitigated. A prior art arrangement of a photodiode and an accompanying amplifier circuit that illustrates the potential for interference is depicted in FIG. 1.

FIG. 1 is a circuit schematic 100 depicting a photo-detector module 110 connected to an amplifier integrated circuit 150. The photo-detector module 110 of FIG. 1 is made up of the photodiode 120 itself and two photo-detector module output pads 130. The photodiode 120 is connected to the photo-detector module output pads 130 such that a photocurrent, created when the photodiode 120 is excited by received light stimulus, is passed to these pads 130.

The amplifier integrated circuit 150 is responsive to the photo-detector module 110 via bond-wires 140 which connect the photo-detector module output pads 130 and the amplifier integrated circuit input pads 160. In the example of FIG. 1, the input to the amplifier integrated circuitry is represented by a transistor 170 and a capacitor 165. The product of the amplifier integrated circuit 150 is output to subsequent circuitry via the amplifier output pads 180. It should be recognized that the amplifier contained in the amplifier integrated circuit 150 could be one of many variations that would be recognized by one skilled in the art. In one embodiment, a transimpedance amplifier is utilized such that the photocurrent signal supplied by the photo-detector module 110 is converted into a voltage signal that may be easily utilized by circuitry downstream from the photo-detector module 110 and amplifier integrated circuit 150.

FIG. 2 depicts a prior art circuit layout diagram of a photodiode-amplifier circuit combination 200 consistent with the circuit schematic of FIG. 1. In FIG. 2, the photo-detector module 110 containing a photodiode 120 is connected to an amplifier integrated circuit 150 via bond-wires 140 which connect the photo-detector module output pads 130 and the amplifier integrated circuit input pads 160.

FIG. 3 depicts a prior art three-dimensional simulation view of a photodiode-amplifier circuit combination 300. In FIG. 3, the photo-detector module 110 containing a photodiode 120 is connected to the amplifier integrated circuit 150 via bond-wires 140 which connect the photo-detector module output pads 130 and the amplifier integrated circuit input pads 160. The amplifier integrated circuit 150 may contain a variety of configurations as would be recognized by one skilled in the art and described with reference to FIG. 1 previously.

While the configuration of the prior art photodiode-amplifier circuit combinations of FIGS. 1-3 may be somewhat effective in propagating the photocurrent generated by the photodiode 120 to the amplifier integrated circuit 150 for amplification, the configuration is sub-optimal due to its susceptibility to interference by the amplifier output signal or by other signals present in the system containing the photo-detector module 110 and the amplifier integrated circuit 150. This susceptibility to interference can be seen with reference back to FIG. 1. When a photo-detector module 110 is connected to an amplifier integrated circuit 150 by means of two parallel bond-wires 140 as in FIG. 1, a single high Q RF loop is formed that acts as a receiving antenna. This high Q RF loop is highlighted by the dashed line 190 in FIG. 1. This loop antenna 190 is very susceptible to output to input coupling from the output 180 of the amplifier integrated circuit 150 and interference from other signals present in the overall system causing signal distortion and possibly device instability. In other words, changing magnetic fields from the amplifier output 180 or other elements in the system passing through the loop antenna 190 may create a loop current which interferes with the photocurrent produced by the photo-detector module 110 resulting in distortion and possible instability.

Efforts have been made to combat the interference effects facilitated by the high Q RF loop 190 of FIG. 1. One such effort is shown in FIG. 4. FIG. 4 is a circuit schematic depicting a three-terminal photo-detector module 410 connected to an amplifier integrated circuit 450. The photo-detector module 410 of FIG. 4 is made up of the three-terminal photodiode 420 and three photo-detector module output pads 430.

The amplifier integrated circuit 450 is responsive to the photo-detector module 410 via bond-wires 440 which connect the photo-detector module output pads 430 and the amplifier integrated circuit input pads 460. In the example of FIG. 4, the amplifier integrated circuitry is represented by a transistor 470 and a capacitor 465.

The configuration of FIG. 4 is superior to the design of FIG. 1 in that it mitigates the output to input interference and interference from other system sources by introducing two counter-rotating loops 490 into the photodiode-amplifier circuit combination 400. These loops 490, created by the three-terminal photodiode 420, the bond-wires 440, and the amplifier integrated circuitry act as two high Q RF antennas in a similar manner as the single antenna loop 190 in FIG. 1. However, the net effect of the two loops eliminates much of the electromagnetic interference experienced by the circuit of FIG. 1 due to the cancellation effect of the two counter-rotating loops 490. More specifically, any induction current generated in one of the loops 490 by changing magnetic fields passing through that loop antenna 490 is significantly cancelled by the induction current generated in the other loop 490 because the second loop 490 will experience a very similar magnetic field due to the close proximity of the loops. The magnetic field experienced by the second loop will induce a nearly identical in magnitude but opposite current due to the counter-rotating nature of the circuit configuration. The cancellation of the two interference currents results in only the signal current generated by the photodiode 420 being propagated to the amplifier integrated circuit 450.

While the circuit configuration of FIG. 4 is superior to the configuration of FIG. 1 in its resistance to both internal and external interference, it is less desirable in terms of cost. The circuit of FIG. 4 requires the more expensive three-terminal photodiode 420, requires an additional output and input pad in the photodiode-amplifier combination 400, as well as an extra bond-wire 440. In addition to the increased monetary cost due to the added required components, the configuration of FIG. 4 also increases the space costs when compared to the configuration of FIG. 1. In an environment where system costs and system footprint reduction are critical, the added cost and space requirements of the configuration of FIG. 4 may make this design unacceptable despite the improvement in electromagnetic interference reduction.

Therefore, there exists a present need for a sensor-amplifier circuit which offers improved electromagnetic interference reduction while avoiding the increased monetary and footprint size costs of existing solutions.

### BRIEF DESCRIPTION OF THE DRAWINGS

FIG. 1 is a circuit schematic depicting a photo-detector module connected to an amplifier integrated circuit.

FIG. 2 depicts a prior art circuit layout diagram of a photodiode-amplifier circuit combination.

FIG. 3 depicts a prior art three-dimensional software simulation view of a photodiode-amplifier circuit combination.

FIG. 4 is a circuit schematic depicting a three-terminal photo-detector module connected to an amplifier integrated circuit.

FIG. 5 is a circuit schematic depicting a photo-detector module connected to an amplifier integrated circuit utilizing cross-over bond-wires.

FIG. 6 depicts a circuit layout diagram of a photodiode-amplifier circuit combination utilizing cross-over bond-wires.

FIG. 7 depicts a three-dimensional software simulation view of a photodiode-amplifier circuit combination utilizing cross-over bond-wires.

FIG. 8 is a circuit schematic depicting a three-terminal photo-detector module connected to an amplifier integrated circuit via cross-over bond-wires.

FIG. 9 is a block diagram illustrating a method of generating an amplified representation of a sensor signal that is resistant to electromagnetic interference.

FIG. 10 is a block diagram illustrating a method of fabricating a sensor-amplifier circuit that is resistant to electromagnetic interference.

### DETAILED DESCRIPTION

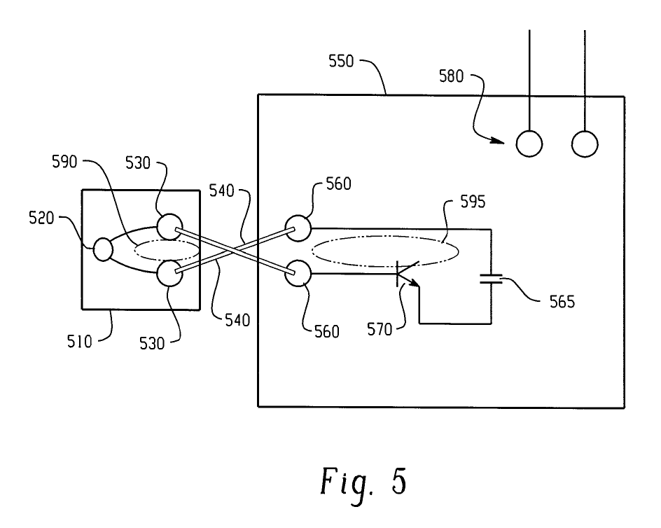

FIG. 5 is a circuit schematic depicting a photo-detector module connected to an amplifier integrated circuit utilizing cross-over bond-wires. The photo-detector module 510 of FIG. 5 is made up of the photodiode 520 itself and two photo-detector module output pads 530. The photodiode 520 is connected to the photo-detector module output pads 530 such that a photocurrent is created when the photodiode 520 is excited by received light stimulus.

The amplifier integrated circuit 550 is responsive to the photo-detector module 510 via a pair of cross-over bond-wires 540 which connect the photo-detector module output pads 530 and the amplifier integrated circuit input pads 560. In the example of FIG. 5, the input to the amplifier integrated circuitry is represented by a transistor 570 and a capacitor 565. The product of the amplifier integrated circuit 550 is output to subsequent circuitry via the amplifier output pads 580.

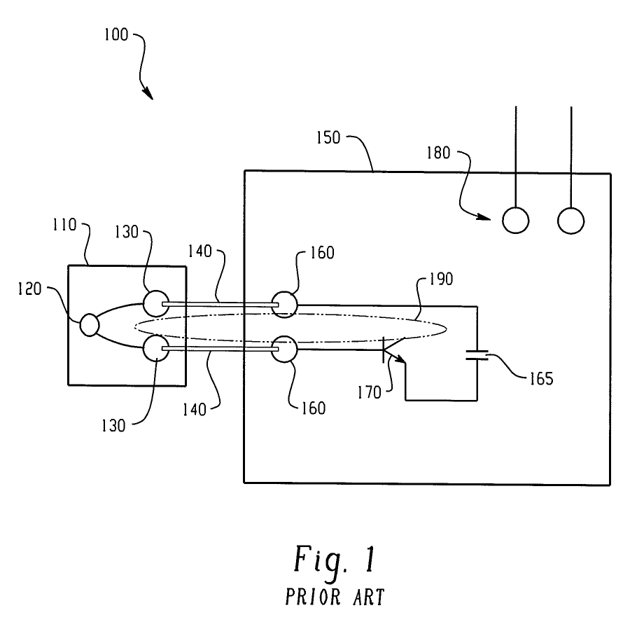

The bond-wires 540 in the configuration of FIG. 5 are considered to be in a cross-over arrangement because, in contrast to the configuration of FIG. 1, the bond-wires do not run in parallel between the photo-detector module and the amplifier integrated circuit but instead cross over one another. Thus, one bond-wire 540 connects the top photo-detector module output pad 530 as depicted in FIG. 5 to the bottom amplifier integrated circuit input pad 560, and the second bond-wire connects the bottom photo-detector module output pad 530 to the top amplifier integrated circuit input pad 560.

The configuration of FIG. 5 is advantageous in its ability to resist electromagnetic interference from the amplifier output 580 and other interference in the system while not sacrificing space and component cost. When a photo-detector module 510 is connected to an amplifier integrated circuit 550 by means of two cross-over bond-wires 540 as in FIG. 5, two high Q RF loops are formed that act as receiving antennae. When the two loop antennae 590 and 595 of FIG. 5 are exposed to changing magnetic fields, currents are induced within the photodiode-amplifier circuit. Due to the close proximity of the two loop antennae 590 and 595, the change in magnetic fields experienced by the loops will often be near identical inducing two near-equal currents in the photodiode-amplifier circuit. However, due to the counter-rotating nature of the two loops created by the cross-over bond-wires, the two induced currents are in opposite directions and effectively have a cancelling effect on one another. This greatly diminishes the problematic electromagnetic interferences, effectively leaving only the photocurrent generated by the photodiode in photodiode-amplifier circuit for amplification.

Measured results show that systems consistent to the design depicted in FIG. 5 utilizing cross-over bond-wires exhibit significant improvement in interference resistance over other fabrication designs consistent with the configuration of FIG. 1 which lack interference mitigation mechanisms. These tests identify a significant reduction in feedback and output to input coupling. These results are shown to continue to hold in applications with high-gain amplification where electromagnetic interference from the amplifier output is greatly increased where circuits without proper interference mitigation may be driven to instability and unusability.

It should be noted that the crossing of the bond-wires 540 does not electrically connect the bond-wires. The bond-wires may be insulated from one another by insulators such as silicon dioxide, Teflon, glass, steatite, plastic, varnish, fiberglass, paper, wood, mineral oil, high pressure insulating gas, polyethylene, crosslinked polyethylene, PVC, rubber, rubber-like polymers, silicone, compressed inorganic powder, asbestos, and other insulators which would be recognized by one skilled in the art.

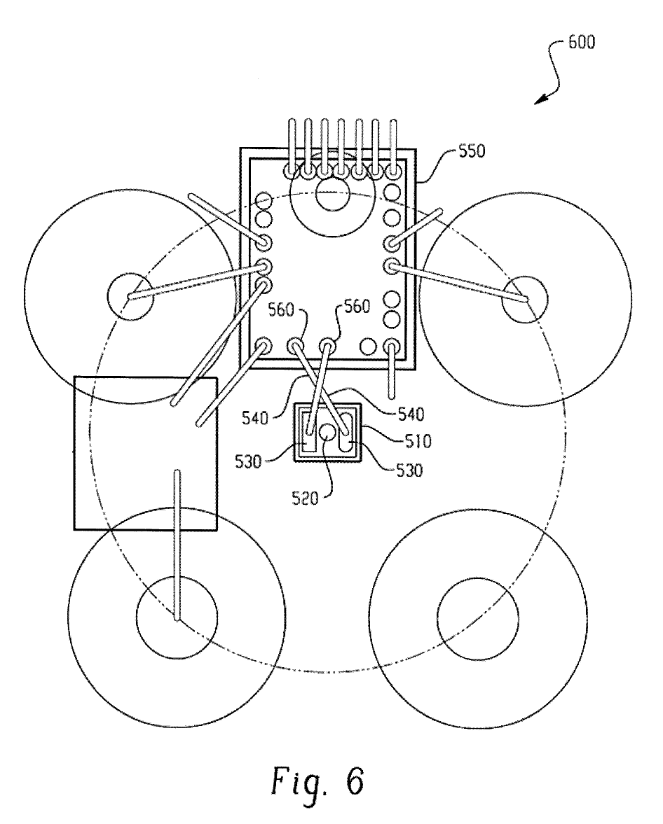

FIG. 6 depicts a circuit layout diagram of a photodiode-amplifier circuit combination 600 utilizing cross-over bond-wires consistent with the circuit schematic of FIG. 5. In FIG. 6, the photo-detector module 510 containing a photodiode 520 is connected to an amplifier integrated circuit 550 via cross-over bond-wires 540 which connect the photo-detector module output pads 530 and the amplifier integrated circuit input pads 560.

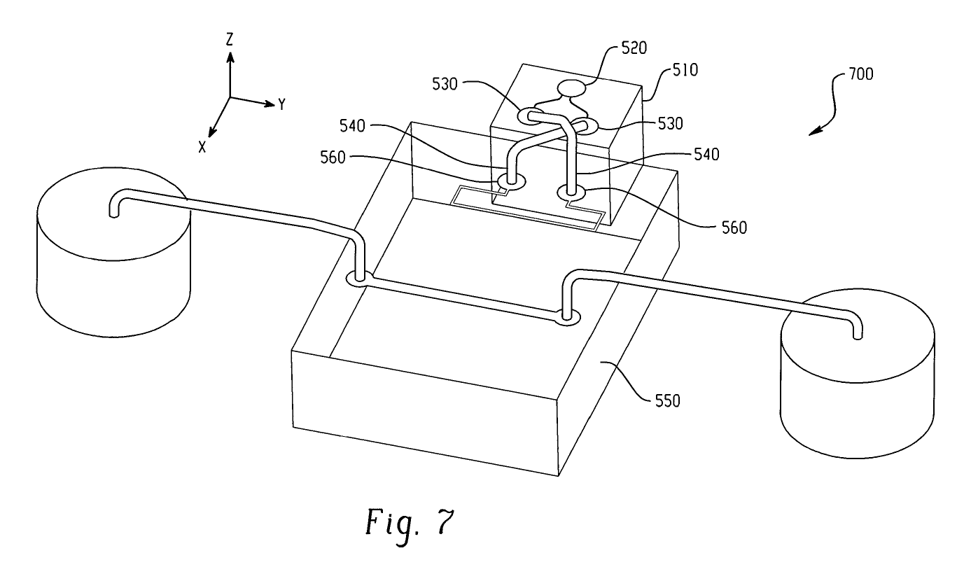

FIG. 7 depicts a three-dimensional software simulation view of a photodiode-amplifier circuit combination 700 utilizing cross-over bond-wires for modeling the contribution of the cross-over bond-wires to interference suppression. In FIG. 7, the photo-detector module 510 containing a photodiode 520 is connected to the amplifier integrated circuit 550 via cross-over bond-wires 540 which connect the photo-detector module output pads 530 and the amplifier integrated circuit input pads 560. The amplifier integrated circuit 550 may contain a variety of configurations as would be recognized by one skilled in the art and described with reference to FIG. 5 previously.

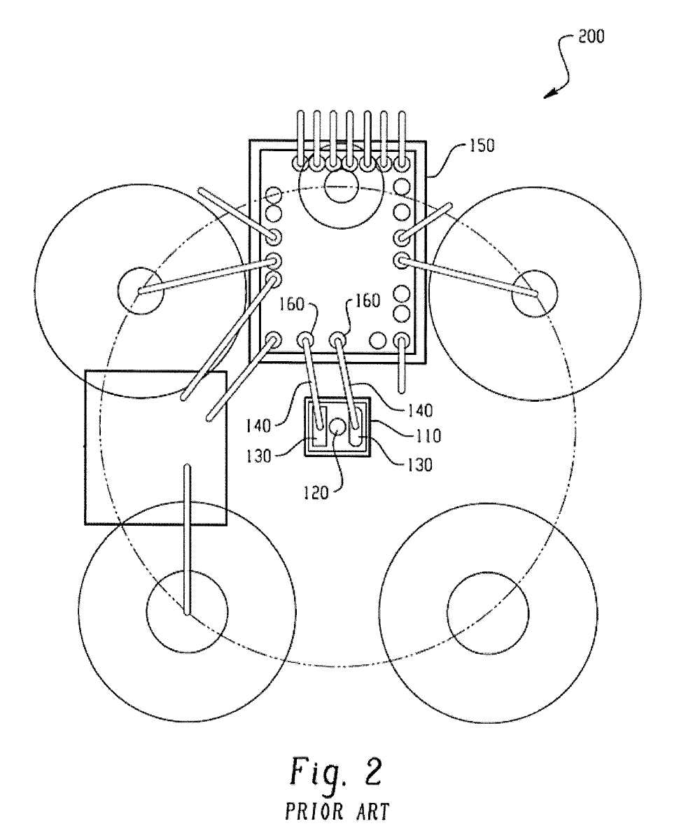

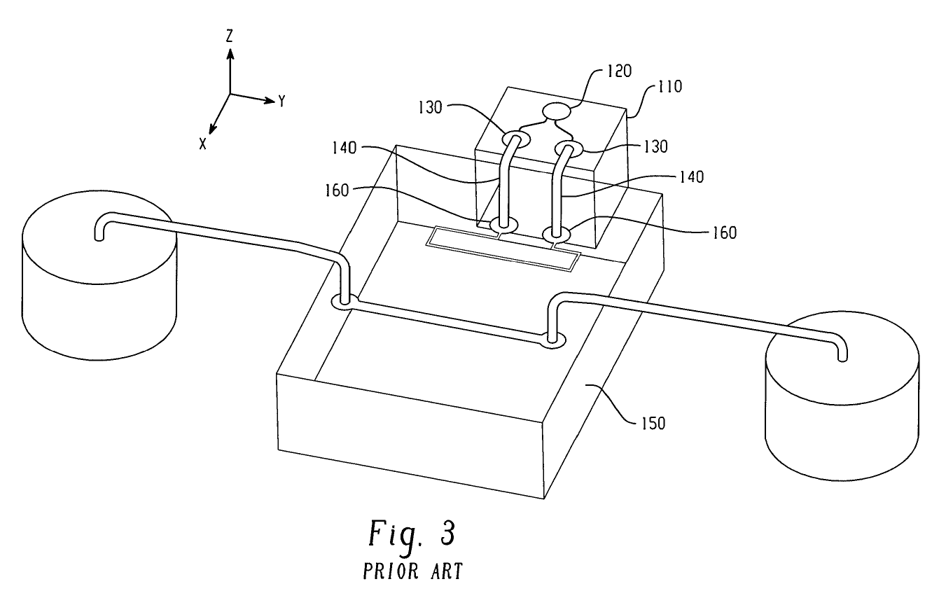

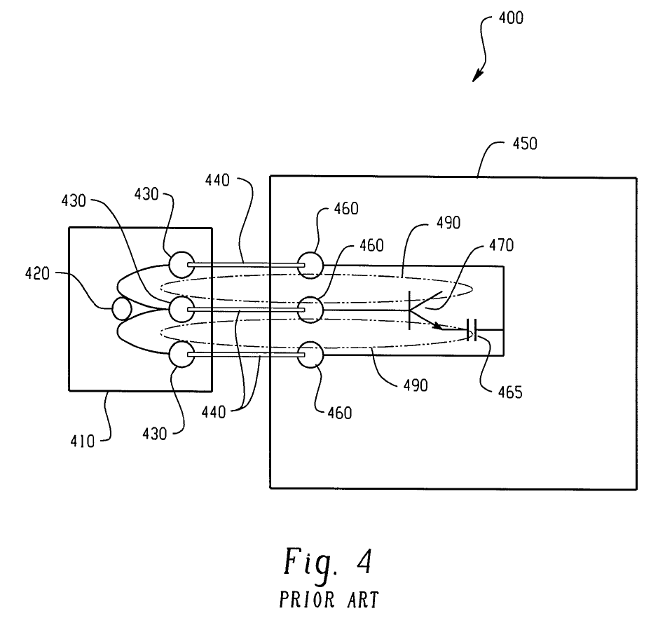

While the configurations of FIGS. 5-7 offer marked improvement in electromagnetic signal interference resistance, the configurations are able to accomplish this without any material increase in space or component costs. Comparing FIGS. 5, 6, and 7 to FIGS. 1, 2, and 3 respectively, it can be seen that the circuits of FIGS. 5, 6, and 7 accomplish the goal of reducing interference without any significant extra fabrication space costs. In addition, the only significant difference in fabrication parts costs is the difference in bond-wire lengths required to accomplish the cross-over bond-wire configuration. This is in contrast to the prior art solution depicted in FIG. 4. The configuration of FIG. 4 requires the more expensive three-terminal photodiode, an extra bond-wire, and additional wire trace lengths to attempt to combat induced current interference. Additionally, the configuration of FIG. 4 requires a larger fabrication area than the solution of FIG. 5 which is able to accomplish interference resistance in the same amount of space as the prior art configuration of FIGS. 1-3.

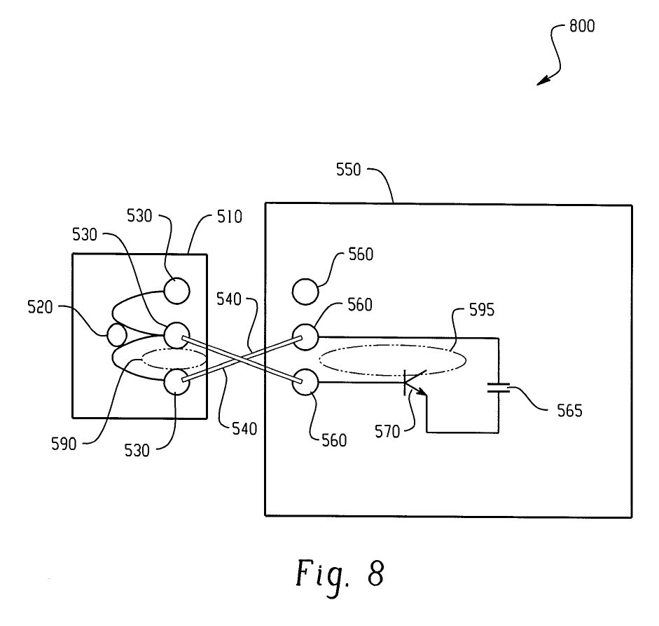

The cost savings of designs consistent with FIG. 5 can be seen with reference to the illustration of FIG. 8. FIG. 8 is a circuit schematic depicting a three-terminal photo-detector module 510 connected to an amplifier integrated circuit 550 via cross-over bond-wires. The photo-detector module 510 of FIG. 8 is made up of the three-terminal photodiode 520 and three photo-detector module output pads 530. The amplifier integrated circuit 550 is responsive to the photo-detector module 510 via two cross-over bond-wires 540 which connect the photo-detector module output pads 530 and the amplifier integrated circuit input pads 560. In the example of FIG. 8, the amplifier integrated circuitry is represented by a transistor 570 and a capacitor 565.

FIG. 8 illustrates that the cross-over bond-wire configuration may be utilized with a three-terminal photodiode 520 to produce the two counter-rotating loops 590 and 595 in close proximity similar to the solution of FIG. 4. This results in improved electromagnetic interference resistance while still offering the opportunity for space cost reduction. As can be seen in FIG. 8, the cross-over bond-wires eliminate the need for the third amplifier circuit input pin 560 because the cross-over bond-wires create two counter-rotating loop antennae for improved interference resistance without the need for a third bond-wire. Thus, the third amplifier circuit input pin 560 may be eliminated from the circuit design if desired. Removal of the input pin and any associated wire traces results in a reduction in part costs for the photodiode-amplifier circuit combination as well as the potential for footprint size reductions on the amplifier circuit if desired.

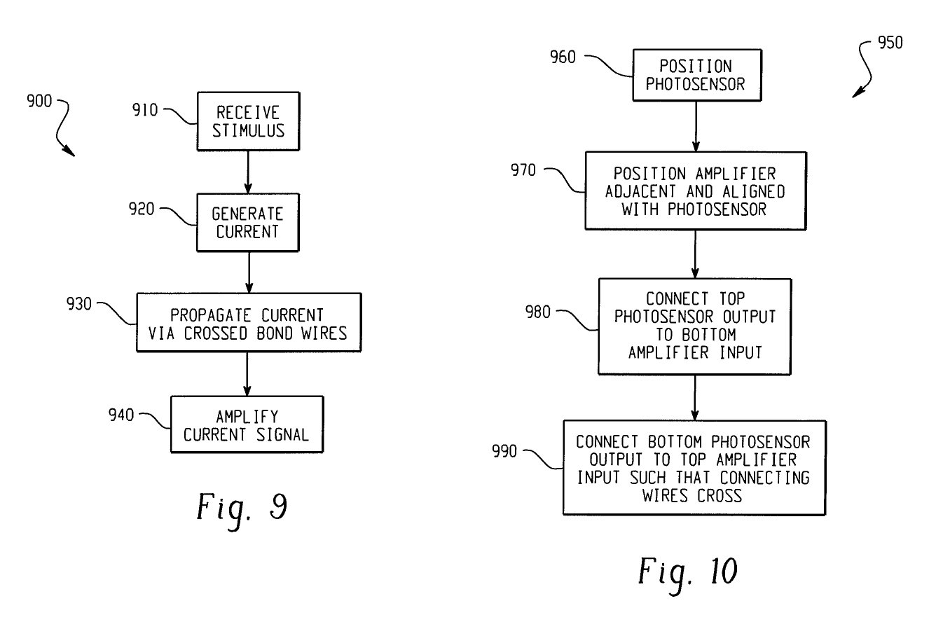

FIG. 9 is a block diagram illustrating a method of generating an amplified representation of a sensor signal that is resistant to electromagnetic interference. In step 910, the sensor receives a stimulus. In response to this stimulus, the sensor generates a current in step 920 of the block diagram. This generated current is propagated to an amplifier circuit via crossed bond-wires in step 930, offering protection from electromagnetic interference. The propagated signal is then amplified in step 940.

FIG. 10 is a block diagram illustrating a method of fabricating a sensor-amplifier circuit that is resistant to electromagnetic interference. In steps 960 and 970, the sensor and amplifier are positioned such that their inputs and outputs respectively are aligned. Once the sensor and amplifier are positioned, a first output of the sensor should be connected to an input of the amplifier as shown in step 980. The second output of the sensor should then be connected to the other input of the amplifier as detailed in step 990 such that the connecting bond-wires cross over one another.

In one embodiment, the anode output of the sensor module is connected to the amplifier first. This connection is followed by the connection of the cathode output of the sensor module to the amplifier such that the second connection crosses over the first connection one time. This configuration allows the cathode bond-wire to shield the anode bond-wire which is often the output line utilized for signal amplification due to the asymmetric nature of photodiodes. While this configuration may be preferred in some applications, it should be noted that the cross-over bond-wire configuration may be effective in interference resistance regardless of the order of wire crossing.

It should also be noted that while a photodiode-amplifier circuit combination has been used to illustrate the teachings of this application, one skilled in the art would recognize that these teachings may be adapted to other sensor-amplifier configurations. Other exemplary sensors include heat-sensors, temperature-sensors, force-sensors, pressure-sensors, flow-sensors, viscosity-sensors, density-sensors, accelerometers, chemical-sensors, as well as others.

It is claimed:

1. A receiver module comprising:
a sensor for receiving a stimulus having a plurality of output ports for providing a current in response to the stimulus;
an integrated circuit that includes an integrated amplifier circuit, the integrated circuit including a plurality of input ports for receiving the current;
a first bond-wire physically connecting a first sensor output port to a first integrated circuit input port; and
a second bond-wire physically connecting a second sensor output port to a second integrated circuit input port, the second bond-wire being connected such that it crosses over the first bond-wire creating two loops that interact to reduce interference.

2. The receiver module of claim 1, wherein the two loops are counter-rotating loops.

3. The receiver module of claim 2, wherein the two counter-rotating loops are in anti-phase with each other such that a field picked up in each loop will destructively interfere with the field picked up in the other loop creating field rejection.

4. The receiver module of claim 1, wherein the sensor is a photosensor.

5. The receiver module of claim 4, wherein the photosensor provides a photocurrent in response to the receipt of light stimulus.

6. The receiver module of claim 1, wherein the integrated amplifier circuit is a transimpedance amplifier circuit.

7. The receiver module of claim 1, wherein the second bond-wire crosses the first bond-wire exactly one time.

8. The receiver module of claim 1, wherein the first bond-wire is electrically insulated from the second bond-wire by air.

9. The receiver module of claim 1, wherein the first bond-wire and second bond-wire are individually insulated by a coating selected from the group consisting of silicon dioxide, teflon, glass, steatite, plastic, varnish, fiberglass, paper, wood, mineral oil, high pressure insulating gas, polyethylene, crosslinked polyethylene, PVC, rubber, rubber-like polymers, silicone, compressed inorganic powder, and asbestos.

10. The receiver module of claim 1 wherein the sensor is positioned adjacent to the integrated circuit.

11. A method of generating an amplified signal having reduced feedback interference comprising:
receiving a stimulus;
generating a current in response to the received stimulus;
propagating the generated current to an amplification circuit via a pair of crossed bond-wires;
amplifying the propagated current signal to produce an output.

12. The method of claim 11, wherein the crossed bond-wires are crossed exactly one time.

13. The method of claim 12, wherein the propagating the generated current via a pair of crossed bond-wires reduces feedback interference by creating two counter-rotating loops that are in anti-phase such that a field picked up in each loop will destructively interfere with the field picked up in the other loop creating field rejection.

14. The method of claim 11 wherein the stimulus received is light.

15. The method of claim 11 wherein the amplifying of the propagated current signal is accomplished by a transimpedance amplifier.

16. A method of fabricating an optical receiver module comprising:
positioning a photosensor module having a first output and a second output;
positioning an integrated amplifier circuit having a first input and a second input near the photosensor module such that the first and second outputs are accessible to the first and second inputs;
connecting the first photosensor module output to the second integrated amplifier input with a first bond-wire;
connecting the second photosensor module output to the first integrated amplifier input with a second bond-wire such that the first bond-wire and second bond-wire cross.

17. The method of claim 16, wherein the first bond-wire and second bond-wire are separated by air.

18. The receiver module of claim 16, wherein the first bond-wire and second bond-wire are individually insulated by a coating selected from the group consisting of silicon dioxide, teflon, glass, steatite, plastic, varnish, fiberglass, paper, wood, mineral oil, high pressure insulating gas, polyethylene, crosslinked polyethylene, PVC, rubber, rubber-like polymers, silicone, compressed inorganic powder, and asbestos.

19. The method of claim 16, wherein the second bond-wire crosses over the first bond-wire one time.

20. The method of claim 16, wherein the first output corresponds to an anode output of the photosensor module.

21. The method of claim 18, wherein the first output corresponds to an anode output of the photosensor module.
